(19) United States
(12) Patent Application Publication
(10) Pub. No.: US 2017/0132899 A1
(43) Pub. Date: May 11, 2017

(54) Personal Locating System

(71) Applicant: Constance Theocharous, Allendale, NJ (US)

(72) Inventor: Constance Theocharous, Allendale, NJ (US)

(21) Appl. No.: 15/239,785

(22) Filed: Aug. 17, 2016

Related U.S. Application Data
(60) Provisional application No. 62/205,988, filed on Aug. 17, 2015.

(51) Int. Cl. G08B 21/02

(52) U.S. Cl. CPC G08B 21/0269

(57) ABSTRACT

A personal locating system for locating, tracking, and finding lost, wandering, abducted, or disoriented individuals is provided. The personal locating system comprises a bracelet having a first end and a second end and a GPS tracking chip mounted to the bracelet. A locking mechanism locks the first end of bracelet to the second end of the bracelet. The bracelet inhibits episodes of lost, kidnapped, distressed, incapacitated, or wayward individuals.

### CLAIM OF PRIORITY

This patent application claims priority under 35 USC 119 (e) (1) from U.S. Provisional Patent Application Ser. No. 62/205,988 filed Aug. 17, 2015, of common inventorship herewith entitled, “People Finder,” which is incorporated herein by reference as though the same were set forth in its entirety.

### FIELD OF THE INVENTION

The present invention pertains to the field of GPS tracking systems, and more specifically to the field of personal monitoring devices for locating individuals.

### BACKGROUND OF THE INVENTION

When good people encounter pure evil, the results are often tragic. Every day, news media reports another story of a child abducted and killed, a shooting rampage at a high school or college, a coed missing and found in a shallow grave. Home invasions, kidnappings, rapes and murders occur throughout the world on a daily basis.

Approximately eight hundred thousand children are reported missing each year, and approximately five hundred thousand go missing without ever being reported. The vast majority of these children are abducted by an estranged parent and a lot of them are runaways, but a substantial number of them are abducted by child molesters, pedophiles and murderers, and the end is predictably tragic.

Child abductions are particularly difficult for law enforcement agencies. When a child is reported missing, there is often no immediate evidence of the abduction. Even if the police suspect an abduction, they still have no idea where the child has been taken. One common element of many of these tragedies is the tendency of a child to wander away from a supervising adult. Once the child is out of sight, finding them quickly is all important. Some parents or caregivers employ a retractable leash with their children, but many people find this method distasteful and impractical.

The prior art has put forth several designs for personal monitoring devices for locating individuals. Among these are:

US Patent 2012/0229273 to Douglas Rea Standing Bear II Michael and Rosemary R. Bryant describes real time active tracking devices for family security, consisting of embedded chip, handheld portable units and a home base unit. Tracking chips are embedded primarily in socks, and interface with the portable home base units which are purchased and sold separately. Consumers activate the tracking chip by scanning the article into the portable or home base unit, which then automatically begins to display location and movement of the chip. Pretty Paw software allows real time determination of variable movement and location, tracking parameters, including line of sight and long range global positioning tracking, phone interface, emergency protocols and USB parameters. Consumers utilize Pretty Paw technology to notify law enforcement of emergencies in real time by providing instantaneous GPS and significant probable cause to appropriate law enforcement computers and dispatch centers concerning individual adult and child abductions.

U.S. Pat. No. 8,253,570 to William B. McBride describes a device that allows soldiers to find lost or captured comrades using standard RFID technology wherein the missing soldier has an RFID tag on his person. The searcher uses a reader that uses a directional antenna in order to increase system range. The reader also has a digital compass thereon so that once the reader determines the direction to the missing soldier, the compass outputs the direction. An RFID radar on the reader determines the distance between the reader and the tag. A GPS chip on the reader gives the GPS coordinates of the reader while appropriate circuitry calculates the GPS coordinates for the tag based on the GPS coordinates for the reader, and the direction and distance to the tag. The reader and the tag communicate using spread spectrum technology in order to prevent system corruption.

US Patent 2003/0151506 to Mark Luccketti describes a system for locating a person including a mobile transmitter removably secured to the person and a portable monitoring unit carried by a user monitoring the location of the person. The mobile transmitter receives GPS ranging signals from GPS satellites. Each of the GPS ranging signals includes an offset proportional to the distance of the mobile transmitter from the respective GPS satellite broadcasting the GPS ranging signal. The GPS ranging signals, including the respective offsets, are transmitted to the portable monitoring unit. The portable monitoring unit comprises a GPS circuit which determines the location of the mobile transmitter based on the GPS ranging signals received by the mobile transmitter, and superimposes the location of the mobile transmitter on a map displayed on the portable monitoring unit.

None of these prior art references describe the present invention.

### SUMMARY OF THE INVENTION

It is an object of the present invention to provide a GPS tracking system that is incorporated in a locking bracelet and engineered specifically for use in locating, tracking and finding lost, wandering, abducted, or disoriented individuals, particularly children.

The present invention is a personal locating system for locating, tracking, and finding lost, wandering, abducted, or disoriented individuals. The personal locating system comprises a bracelet having a first end and a second end and a GPS tracking chip mounted to the bracelet. A locking mechanism locks the first end of bracelet to the second end of the bracelet. The bracelet enables inhibits episodes of lost, kidnapped, distressed, incapacitated, or wayward individuals.

In addition, the present invention includes a method for locating, tracking, and finding lost, wandering, abducted, or disoriented individuals. The method comprises providing a bracelet having a first end and a second end, mounting a GPS tracking chip to the bracelet, locking the first end of bracelet to the second end of the bracelet, and inhibiting episodes of lost, kidnapped, distressed, incapacitated, or wayward individuals.

The present invention further includes a personal locating system for locating, tracking, and finding lost, wandering, abducted, or disoriented individuals. The personal locating system comprises a bracelet having a first end and a second end and a GPS tracking chip completely embedded into the bracelet. A locking mechanism locks the first end of bracelet to the second end of the bracelet and a key unlocks the locking mechanism. The bracelet inhibits episodes of lost, kidnapped, distressed, incapacitated, or wayward individuals.

### BRIEF DESCRIPTION OF THE DRAWINGS

FIG. 1 is a perspective view illustrating a personal locating system, constructed in accordance with the present invention, showing various bracelets displayed lengthwise to illustrate various sizes with adjustable locks and lengths.

FIG. 2 is a perspective view illustrating the personal locating system, constructed in accordance with the present invention, showing various bracelets displayed diagonally lengthwise to illustrate various sizes with adjustable locks and lengths.

FIG. 3 is a perspective view illustrating the personal locating system, constructed in accordance with the present invention, showing various bracelets displayed diagonally lengthwise in FIG. 2, showing adjustable locks and lengths.

FIG. 4 is a perspective view illustrating a special security key for a locking bracelet of the personal locating system, constructed in accordance with the present invention, a unique key cut specifically for each bracelet and only issued by the manufacturer of the present invention.

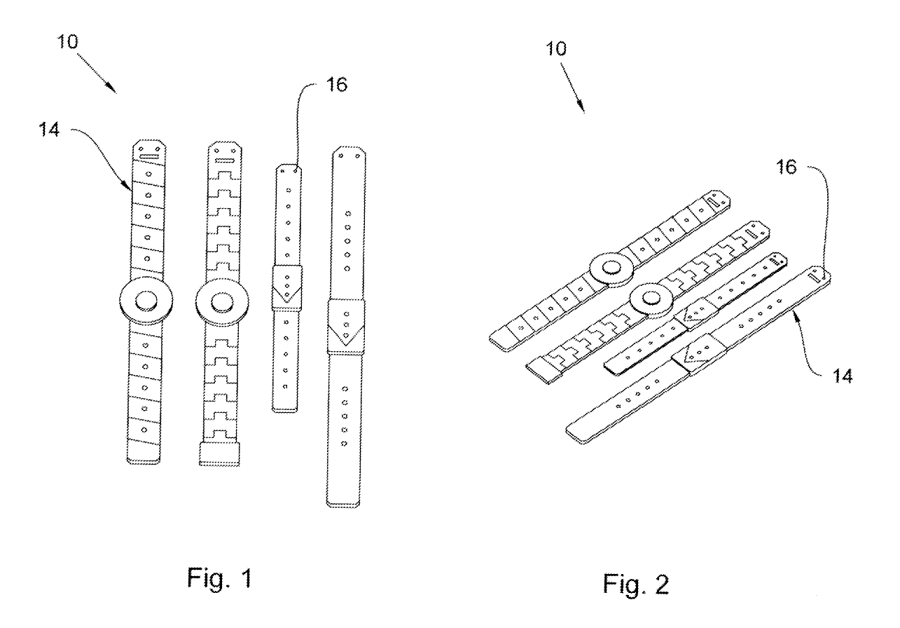

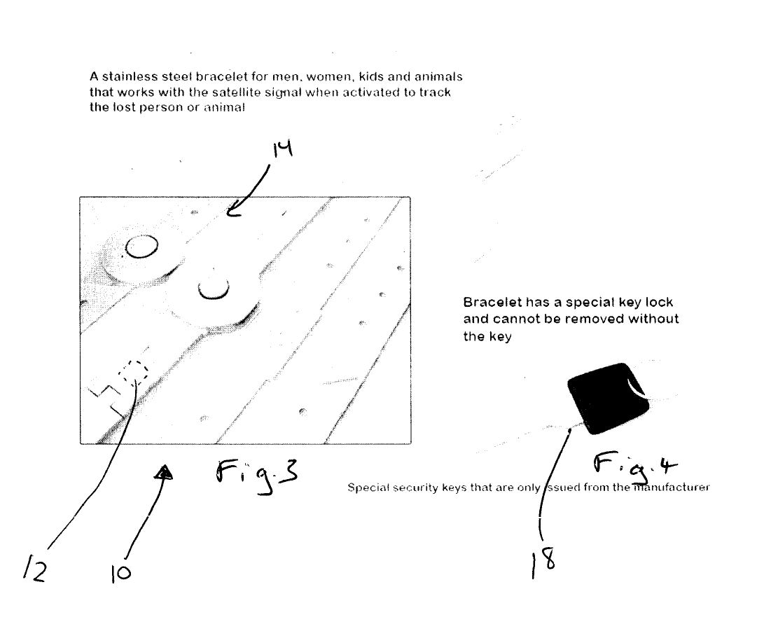

### DETAILED DESCRIPTION OF THE INVENTION

The present invention, hereinafter referred to as the Personal Locating System, indicated generally at 10, is a GPS tracking system engineered specifically for use in locating, tracking, and finding lost, wandering, abducted, or disoriented individuals, particularly children. With a GPS tracking chip 12 incorporated into a locking bracelet 14, the Personal Locating System 10 enables parents and caregivers to prevent episodes of lost, kidnapped, distressed, incapacitated, or wayward children. The Personal Locating System 10 is highly useful in locating and recovering wandering senior age individuals with memory problems. The Personal Locating System 10 also is highly effective in finding lost pets. The Personal Locating System 10 of the present invention provides responsible parties with a compact, effective and wireless means of locating and monitoring those individuals in their care.

A preferred embodiment of the Personal Locating System 10 of the present invention comprises a line of attractive, adjustable, link style, stainless steel bracelets 14 constructed in a variety of styles and sizes appropriate for boys, girls, women, and men. The bracelet 14 contains a keyed lock 16 ensuring that once the bracelet 14 is in place, the bracelet 14 is not removable without unlocking the keyed lock 16 using a unique key 18.

Adults who wear the bracelet 14 of the Personal Locating System 10 of the present invention can carry the key 18 on their person. For children who wear the bracelet 14, their parent or caretaker possesses the key 18. The bracelets 14 are configured to be attractive articles of personal adornment with a slim profile composed of rectangular, rounded or slanted links. A variety of embellishments, designs, and motifs adorn the bracelet 14 of the Personal Locating System 10, enabling wearers to select a bracelet 14 or earring suitable to their personal taste, age, and sex.

Within the steel links of the bracelet 14 of the Personal Locating System 10 of the present invention is a concealed Global Positioning System or GPS tracking chip 12 or receiver. A Radio Frequency or RF receiver and transmitter, the GPS chip 12 receives radio signals from GPS satellites. In conjunction with the satellites, the receiver's precise geographical position is immediately established and tracked through radio signals. The tracking functionality takes place through a smartphone application. The software application is downloadable to three operating systems now in use for the three basic varieties of smartphones which are Apple's iOS operating system, for the iPhone, Google's mobile operating system for the Android, and Microsoft's mobile operating system for Windows phones.

In the event that an individual wearing a bracelet 14 is lost, the GPS tracking system 12 of the Personal Locating System 10 of the present invention is activated through the smartphone software application. The GPS chip 12 in the bracelet begins to receive and transmit radio signals and the user's smartphone becomes a tracking monitor, showing the GPS tracking chip's 12 exact location and movements on a highly detailed GPS map. With the map and monitor as a real time guide, the GPS tracking chip 12 and the individual wearing the bracelet 14 are then located, intercepted, and recovered. Each GPS chip requires individual entry into the smartphone application's database, so that in a household with several children or an Alzheimer's facility with multiple patients, a specific child or senior is quickly singled out for tracking. Because the GPS receiver in the bracelet 14 acts as a radio transmitter, the bracelet 14 component requires electrical power in the form of a compact, button type, lithium ion battery that is easily concealed within a link of the bracelet.

A second embodiment of the Personal Locating System 10 of the present invention is constructed in a line of earrings for girls and women. A third embodiment of the Personal Locating System 10 is constructed in the form of a pet collar for dogs and cats.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A personal locating system for locating, tracking, and finding lost, wandering, abducted, or disoriented individuals, the personal locating system comprising:
a bracelet having a first end and a second end;
a GPS tracking chip mounted to the bracelet; and
a locking mechanism for locking the first end of bracelet to the second end of the bracelet;
wherein the bracelet inhibits episodes of lost, kidnapped, distressed, incapacitated, or wayward individuals.

2. The personal locating system of claim 1 wherein the GPS tracking chip is completely embedded into the bracelet.

3. The personal locating system of claim 2 wherein the bracelet completely surrounds the GPS tracking chip.

4. The personal locating system of claim 1 and further comprising:
a key for unlocking the locking mechanism.

5. The personal locating system of claim 4 wherein the key is unique for each bracelet.

6. The personal locating system of claim 1 wherein the bracelet is an adjustable, link style, stainless steel bracelet constructed in a variety of styles and sizes appropriate for various individuals.

7. The personal locating system of claim 6 and further comprising:
attractive articles of personal adornment mounted on the bracelet.

8. The personal locating system of claim 6 wherein the GPS tracking chip is concealed within the steel links of the bracelet.

9. The personal locating system of claim 1 wherein the bracelet is an earring.

10. The personal locating system of claim 1 wherein the bracelet is a pet collar.

11. The personal locating system of claim 1 wherein the GPS tracking chip receives radio signals from GPS satellites, the precise geographical position immediately established and tracked through radio signals.

12. The personal locating system of claim 11 wherein the tracking system is accomplished through a smartphone application.

13. The personal locating system of claim 12 wherein the tracking system of the GPS tracking chip is activated through the smartphone software application, the GPS tracking chip in the bracelet receiving and transmitting radio signals, the smartphone becoming a tracking monitor, showing the GPS tracking chip's exact real time location and real time movements on a GPS map.

14. The personal locating system of claim 13 wherein the smartphone application is capable of tracking multiple GPS tracking chips.

15. The personal locating system of claim 1 and further comprising:
a compact, button type, lithium ion battery embedded in the bracelet.

16. A method for locating, tracking, and finding lost, wandering, abducted, or disoriented individuals, the method comprising:
providing a bracelet having a first end and a second end;
mounting a GPS tracking chip to the bracelet;
locking the first end of bracelet to the second end of the bracelet; and
inhibiting episodes of lost, kidnapped, distressed, incapacitated, or wayward individuals.

17. A personal locating system for locating, tracking, and finding lost, wandering, abducted, or disoriented individuals, the personal locating system comprising:
a bracelet having a first end and a second end;
a GPS tracking chip completely embedded into the bracelet;
a locking mechanism for locking the first end of bracelet to the second end of the bracelet; and
a key for unlocking the locking mechanism;
wherein the bracelet inhibits episodes of lost, kidnapped, distressed, incapacitated, or wayward individuals.

18. The personal locating system of claim 17 wherein the key is unique for each bracelet.

19. The personal locating system of claim 17 wherein the GPS tracking chip receives radio signals from GPS satellites, the precise geographical position immediately established and tracked through radio signals, the tracking system accomplished through a smartphone application.

20. The personal locating system of claim 19 wherein the tracking system of the GPS tracking chip is activated through the smartphone software application, the GPS tracking chip in the bracelet receiving and transmitting radio signals, the smartphone becoming a tracking monitor, showing the GPS tracking chip's exact real time location and real time movements on a GPS map.
